(19) United States
(12) Patent Application Publication
(10) Pub. No.: US 2019/0188741 A1
(43) Pub. Date: Jun. 20, 2019

(54) FRAUD DETECTION IN DATA SETS USING BAYESIAN NETWORKS

(71) Applicant: Resonate Networks, Inc., Reston, VA (US)

(72) Inventors: Robert Lee WOOD, Ellicott City, MD (US); Futoshi YUMOTO, Fulton, MD (US)

(73) Assignee: Resonate Networks, Inc., Reston, VA (US)

(21) Appl. No.: 16/220,849

(22) Filed: Dec. 14, 2018

Related U.S. Application Data
(60) Provisional application No. 62/598,738, filed on Dec. 14, 2017.

(51) Int. Cl. G06Q 30/02; G06N 7/00; G06F 17/18; G06F 16/23

(52) U.S. Cl. CPC G06Q 30/0203; G06F 16/2365; G06F 17/18; G06N 7/005

(57) ABSTRACT

A computer-implemented method can include receiving multiple survey response sets, where each survey response set includes the responses of a survey taker. A maximum weight spanning tree can be defined. Each node of the maximum weight spanning tree can represent a survey question. Directional edges can connect nodes. A weight for each directional edge can be defined that represents mutual information of two nodes connected by that directional edge. A fraud detection score can be defined for each survey response set based on a conformance of response values for that survey response set to the mutual information represented by the edges of the maximum weight spanning tree. A distribution of the fraud detection scores can be determined, and a subset of the survey response sets can be classified as fraudulent based on the fraud detection scores associated that subset being statistical outliers in the distribution of fraud detection scores.

### CROSS-REFERENCE TO RELATED APPLICATIONS

This application claims the benefit of provisional U.S. Patent Application No. 62/598,738, filed Dec. 14, 2017, the disclosure of which is hereby incorporated by reference in its entirety.

### FIELD

Embodiments described herein generally relate to defining Bayesian networks representative data sets that are permeated with fraudulently supplied information. A subset of the data sets can be identified as fraudulent based on their failure to conform to probabilistic relationships implied by a Bayesian network. In some instances, network addresses can be blacklisted when identified as being associated with fraudulent data.

### BACKGROUND

According to the American Marketing Association's 2017 Gold Report, with corroborating evidence from MDX Research, US companies spend roughly $7-$8 billion on surveys. This is not surprising as a host of critical business intelligence and business decision support functions are sometimes entirely supported on survey results including:
audience measurement;
new product design and targeting;
pricing optimization;
segmentations;
brand management;
insights; etc.

Surveys used to be a local paper-and-pencil activity, but current survey executions are almost entirely done on Web platforms using nationwide panels organized by companies that focus on providing survey information. The bulk of expenses around a survey execution tend to be those associated with providing sample (also referred to survey takers) for the survey. For example, after the survey is created and programmed, costs to make a survey available to a survey taker are typically around $0.50, while a fee of approximately $5 per survey taker is associated with securing a panel of survey takers.

Because of the nature of the panel contracts, survey takers tend to be paid only for successful survey completes. The piecework payment scheme for survey takers creates economic incentives for a survey takers to take as many surveys as quickly as possible. Generally, it is a significant challenge to figure out whether a survey taker is answering survey questions honestly or fraudulently. Professional survey takers learn to quickly catch trick questions. Aside from trick questions, there are no effective techniques for determining whether a survey taker is answering questions quickly and truthfully, or just quickly and choosing essentially random or patterned answers. SurveyMonkey, a large survey provider, estimates that 12-24% of responses coming from web-based survey takers are fraudulent. Qualtrics, another large survey provider, acknowledges fraudulent survey response sets as a major problem, but has also published empirical data suggesting that attempts to defeat survey fraud through attention detection causes survey data to be of lower quality than fraud-permeated survey data obtained without such attention checks.

In some instances, fraudulent survey respondents provide answers that take recognizable forms like straightlining or patterning, but more frequently fraudulent answers supplied by survey takers appear to be random. Sometimes answers are only partially fraudulent, for example, when survey takers answer questions with the “first reasonable response.” Often, however, the answers from fraudulent takers are totally unhelpful, for example when they untruthfully provide “don't know,” or “no opinion,” answers or engage in random picking. Such random-appearing fraudulent answers and not completely truthful answers are not detectable with current techniques and constitute noise, diluting the signal (truthful survey results) sent to the company doing the research.

Recognizing that an unknown portion of survey takers are providing unthought-through answers, some companies sometimes use techniques that frequently fall in the following five categories, each of which suffers from one or more drawbacks:
1. Attention Checks
   a. Red Herring questions
   b. Trap questions
   c. Instructional manipulation checks,
2. Consistency checks,
3. Final ask self-reports,
4. Timing checks, and
5. Pattern checking.

Qualtrics' research has demonstrated that survey takers tend to provide lower quality data in the survey after having to navigate attention checks. Consistency checks, involve the asking of the same or similar questions and also have the chance of behaving like attention checks, negatively impacting survey quality. Final ask self-reports only capture 1-2% of fraudulent survey takers, and pattern checking is very difficult or impossible to do well for non-trivial patterns (e.g., patterns other than straightlining or A,B,C,D,A,B,C,D, etc.). Timing checks are common, but Merkle research has shown a surprising low correlation between fraudulent data and speeders (i.e., test takers that take the survey in times greatly below the average survey interview time). Thus, bad data continues to be a major problem in the industry, leading to $3B loss per year in fraudulent sample, muffled or false business decision signals, and incorrect models. A need therefore exists for improved systems and methods for detecting fraudulent survey answers.

### BRIEF DESCRIPTION OF THE DRAWINGS

FIG. 1 is an example graphical model.

FIG. 2 is an example of a Bayesian network.

FIG. 3 is a flow chart of a method of applying machine-learned graph to survey results to detect fraudulent responses, according to an embodiment.

FIG. 4 is a flow chart of a method of computing a probability of a survey response set, according to an embodiment.

FIG. 5 is an example Bayesian network representing a survey.

FIGS. 6 and 7 are example distributions of Fraud Detection Scores for survey responses.

### DETAILED DESCRIPTION

Embodiments described herein relate to techniques and processes suitable for discovering fraudulent survey responses in a set of survey data, in some instances without the need to specially prepare the survey design ahead of time. In other words, embodiments described herein are able to answer the question “which survey takers in this survey information provided bad answers?” based on the survey results (and in some instances based only on the survey results). Embodiments described herein typically leverage relationships in the dataset itself (e.g., the survey results) and not information obtained from outside the dataset.

In some instances mutual information and/or other relationships in the survey data can be discovered. Formally, the mutual information, I, of two discrete random variables, X and Y, can be defined as follows:

$$I ( X ; Y ) = {\sum }_{y ∈ Y} {\sum }_{x ∈ X} p ( x , y ) log ( \frac{p ( x , y )}{p ( x ) p ( y )} ) \qquad ( 1 )$$

where p(x) and p(y) is the marginal probability distributions of X and Y, and p(x,y) is the joint probability distribution of X and Y. Informally, mutual information describes, given that we know the state of Y, how much does that tell us about the state of X? In a survey, if you ask survey takers their favorite color, the responses to that question may say little about the market value of their houses. If you ask in what neighborhood survey takers live, answers to that question could limit the potential market value of their houses into a fairly narrow range. Thus “favorite color” and “market value of house” have little to no mutual information, but “neighborhood” and “market value of house” would have high mutual information.

Even though survey data may have diluting influences from the bad data being present, it will typically still have enough informational signal to determine questions that have significant mutual information relationships. As discussed above, in question pairs with significant mutual information, nonfraudulent responses should have coordinated answers. For example, if you asked a survey taker's neighborhood, and they answer Bellevue Heights, a neighborhood with 90% of houses between $200k and $250k, but the survey taker marks his or her home value as $100k-$150k, that secondary response has low likelihood given their first response.

Embodiments described herein relate to detecting mutual information relationships in the survey (meaning relationships where I(X;Y)±0), obvious or not, and/or evaluating the performance of survey takers in making reasonably related answers for pairs of questions with mutual information. In this way, individual survey takers' performance on the survey can be evaluated for potential fraud. If after evaluating the joint probability of a survey taker's responses, it is found that joint probability is relatively low (e.g., in absolute terms and/or relative to other survey takers), then that survey taker is either idiosyncratic (i.e., a legitimate statistical outlier), or a survey fraudster. Survey fraud is typically characterized by a significant portion (e.g., 25%) of survey takers appearing at the bottom of a distribution function in a manner that is inconsistent with typical probabilistic outcomes. In some embodiments, survey fraud can be detected via a system or method whereby:
1. The most important pairs of questions, X and Y, (e.g., the questions with the highest mutual information) are found where I(X;Y)±0 (not independent);
2. The likelihood of each survey taker's response is calculated by looking at the conditional probabilities that flow naturally from considering not each question in isolation, but by leveraging the X/Y pairs found in Step 1;
3. There are at least two ways of calculating a survey participant's responses, including:
   a. Looking at the straight probability generated in Step 2, or
   b. Scaling the probability by dividing each likelihood by its marginal probability (i.e., the probability of a response given a fully disconnected Bayesian network);
4. Legitimate responses tend to form a histogram that takes on a bell-like curve, or assumes some form that is above a probability value of zero and to the right of a cluster of survey responses that are characterized by a very low and/or near zero probability. The survey responses that have low/near-zero probability are characteristically fraudulent responses. That is, such low/near-zero probability survey responses are associated with careless survey takers who have a significant number of responses that appear unrelated, independent, and disconnected to other answers already given.
5. Low/near-zero probability survey responses can be marked, eliminated, and/or assigned scores according to their likelihood of being fraudulent.

It may be theoretically possible for a creator of a survey to engage in a laborious and time consuming process of reviewing survey questions for logical relationships. Such a process would almost certainly result in an imperfect and incomplete list of question pairs with assumed mutual information. Such a process would however, be more art than science, and critically would rely on examining survey questions. Embodiments described herein generally relate to empirical methods to detect probabilistic measures of mutual information based on examination of survey responses. In fact, embodiments described herein generally relate to determining mutual information between survey questions without ever analyzing the survey questions themselves.

Systems and methods described herein generally relate to computer-implemented machine learning trained models that allow computers to evaluate mutual information between survey questions according to new, unconventional techniques. Similarly stated, computers implementing methods described herein are able to evaluate survey result data in ways that are impossible without the aid of such a specially programed computer and in ways that previously known computers (e.g., computers not specially programed according to the methods described herein) were unable to perform.

According to an embodiment, a computer-implemented method can be operable to receive multiple survey response sets (e.g., data representing responses to survey questions from multiple survey takers). For ease of discussion, a collection of survey data associated with multiple survey takers is referred to herein as “survey results.” Survey data associated with a single survey taker is referred to as a “survey response set.” A survey response set will typically include “response values” corresponding to answers to individual survey questions or fields.

A directed acyclical graph (DAG) can be defined. The DAG can have nodes representing survey questions. Edges can connect nodes having mutual information. The edges can be directional, implying that a response value for an upstream node (e.g., a response to a question represented by the upstream node) probabilistically reveals information about a response value for a downstream node. The edges can have weights representing the strength of the mutual information between the two nodes connected by that edge. A fraud detection score can be calculated for a survey response set by selecting a second node that is linked to a first node by a first edge pointing from the first node to the second node. A first response value for the survey response set that corresponds to the first node (e.g., an answer to the question represented by the first node) and a second response value for the survey response set that corresponds to the second node can be determined. A probability of the second response value given the first response value can be determined based on the weight of the first edge. A third response value for the survey response set that corresponds to a third node can be determined. The third node being linked by a second edge pointing from the second node to the third node. A probability of the third response value given the second response value can be determined based on the weight of the second edge. A product of the probability of the second response value given the first response value and the probability of the third response value given the second response value can be calculated, on which the fraud detection score can be based. A revised group of survey response sets can be defined by excluding, deleting, or otherwise excising the survey response set from the multiple survey response sets that were received, based on the survey response set having a fraud detection score that is below a threshold value.

According to an embodiment, a computer-implemented method can be operable to receive multiple survey response sets, each survey response set can include a response value for at least one survey question. For example, each survey response set can include the responses of a survey taker. A maximum weight spanning tree can be defined. Each node of the maximum weight spanning tree can represent a survey question. Directional edges can connect nodes. A weight for each directional edge can be defined that represents mutual information of two nodes connected by that directional edge. A fraud detection score can be defined for each survey response set based on a conformance of response values for that survey response set to the mutual information represented by the edges of the maximum weight spanning tree. A distribution of the fraud detection scores can be determined, and a subset of the survey response sets can be classified as fraudulent based on the fraud detection scores associated that subset being statistical outliers in the distribution of fraud detection scores.

According to an embodiment, survey response sets can be received. For example, each survey response set can originate from a different survey taker and can include response values for questions of the survey. A Bayesian network that represents the survey results can be defined. Nodes of the Bayesian network can represent survey questions. Directional edges can connect the nodes and can represent the amount of information a response value for the upstream node reveals about a value of a response value for a question represented by a downstream node. A first response value for a first question and a second response value for a second question can be selected from one of the survey response sets. The first question can be represented by a first node of the Bayesian network and the second question can be represented by a second node of the Bayesian network. The second node can be downstream of the first node. A fraud detection score for the survey response set can be calculated based on the first response value, the second response value, and a weight of an edge that is between the first node and the second node. The survey response set can be marked as fraudulent based on the fraud detection score being below a threshold value.

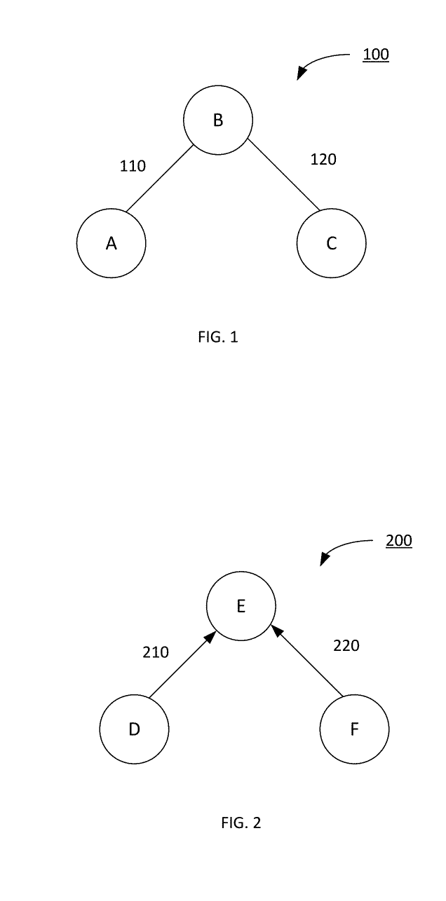

FIG. 1 is an example graphical model 100 showing three nodes and two edges. Graphical models are generally suitable for representing the relationship among variables with conditional dependencies. The nodes, A, B, and C, of the graphical model 100 represent variables and direct conditional relationships between the variables are represented by edges 110 and 120. Similarly stated, graphical model 110 implies that nodes A and B are conditionally dependent and that nodes C and B are conditionally dependent. The lack of an edge connecting nodes A and C indicates that nodes A and C are conditionally independent, given B. Specifically, graphical model 100 does not prove that nodes A and C are independent variables, but rather implies that the impact of the value of the variable C on variable A is encoded in the state of variable B.

Thus, graphical model 100 can be defined as the set M={N,E,P} where N is the set of nodes, each of which represents a variable, E is the set of edges between the nodes representing the direct and conditional relationships between connected nodes, and P is the set of probability distribution functions associated with each node or variable. As discussed in further detail herein, the nodes A, B, C, can represent survey questions, the edges 110, 120 can represent mutual information or other measure of how one connected node effects another connected node.

FIG. 2 is an example of a Bayesian network 200 showing three nodes, D, E, and F, and two directed edges, 210 and 220. Bayesian networks are a special category of a graphical model. The edges 210 and 220 of Bayesian network 200 are directed, meaning a value of a variable represented by node D implies information about a value of a variable represented by node E. Similarly, a value of the variable represented by node F implies information about a value of a variable represented by node E. Often, this directional implication is interpreted as a “causal” relationship. For example, if E is a variable associated with “sidewalk wetness” and D is a variable associated with “rainfall,” then a large value for D implies a large value for E, but it does not necessarily follow that E implies D. For example, the sidewalk could be wet when it is not raining if a sprinkler is operating, which could be represented by node F.

Bayesian networks are a special form of probabilistic Directed Acyclic Graphs (DAGs). Bayesian network 200 is also a DAG, because the Bayesian network 200 does not include any “cycles.” Formally, if a path is a sequence of edges such that the ending of one ray is the beginning of the next, then a Bayesian network is a DAG if there are no non-null paths in graph going from any of the nodes to itself. For terminology's sake, also note here that in the above D−>E <−F graph, D and F are considered a parent or upstream nodes to E, and E is a child or downstream node.

The following probability function describes any one state of a DAG (e.g., an overall probability of a set of survey responses). For the vector of nodes in a Bayesian network N=<N₁, N₂, . . . , Nₙ>:

$$P ( X ) = {\prod }_{i = 1}^{n} P ( {X}_{i} \vert parents ( {X}_{i} ) ) \qquad ( 2 )$$

Thus, in this model of the survey relationships the joint probability of any one state is just the product of the conditional probabilities of each node given the state of its parent nodes.

### Discovering Bayesian Networks Through Machine Learning

A specific class of machine learning processes are discussed herein that are suitable to infer relationships between survey questions by examining the survey results. Similarly stated, machine learning processes described in this section have been specifically selected as being suitable to automatically infer relationships between survey questions based on survey results (and, in some instances, based only on survey results). The combination of the below-described machine learning techniques and survey result information allows computers to automatically develop and provide insights into survey-taker behavior that was not previously possible.

One approach to creating a graph from a data set (e.g., survey results) is to create the Maximum Weight Spanning Tree (MWST). If one considers a graph G that contains a set of nodes N and all possible edges E connecting each node to each other node , then a spanning tree is any subset of <N,E>that contains all nodes N, but only enough edges so that each node is connected to at least one other node. From this it is easy to see that there would naturally be no cycles in a spanning tree.

As a next step, consider “weight.” The weight of an edge E is tied to how strongly “connected” two nodes are. In other words, how much does information about the state of one node imply about the state of the other node? In some instances, a measure like mutual information can be used, represented as follows. The mutual information, I(X,Y) of two random discrete variables X and Y, with a joint probability distribution D_{xy}(x, y) would be given as above. In other instances, a simultaneity metric, KL Divergence, or other measure of one variable's influence on another could also be used.

Once the nodes and the weights between each of the nodes are defined, the maximum weight spanning tree is defined as a spanning tree with the maximum combined weight, which may or may not be unique. Kruskal's method, Prime's method, or any other suitable technique can be used to generate a MWST. Kruskal's method has the advantage of being only having O((n−1)−log n) complexity, or for Prime's method, O(n²), where n is the number of nodes. Techniques for generating a MWST are often used as a first iteration, with other techniques used after building and correcting the graph structure from that point, because Kruskal's method and Prime's method often place artificial restraints on the graph structure, which can result in suboptimal graphs.

Equivalence Class (EQ) is another suitable technique for defining a MWST. The time to resolution for EQ methods can be exponential based on the number of nodes involved. EQ, however, has the advantage of searching between equivalence classes, and not every possible graph structure. Often this leads to better results and a significant reduction in network graph times relative to, for example Kruskal's method and/or Prime's method.

Tabu is another suitable technique for defining a MWST. Tabu follows a greedy algorithm during certain phases of the optimization search. Since greedy algorithms can lead to local instead of global optimum, the Tabu methods will typically begin searches of best approaches that do not necessarily improve the score. The size of the list of non-greedy directions is known as the Tabu List Size, and is controlled by the operator. Tabu has previously been shown to provide useful insights into the connectedness of academic research. Other related techniques include greedy search (GS), the incremental association Markov blanket (IAMB) method, and the hill climbing (HC) method.

For many of the methods used to create or define a MWST, a Structural Coefficient (α) is first set or chosen. When defining a MWST, tradeoffs typically exist between network fit and network complexity. Frequently, methods for defining MWST seek to find the Minimum Description Length (MDL). For a network N and dataset D, the MDL is:

MDL(N ,D)=αDL(N)+DL(D/N)
which also represents the tradeoff between complexity and fit determined by alpha. An alpha of zero would mean that network fit is all that matters—whatever the complexity. The higher the alpha, the more weight to Occam's (MDL) simplicity. In many instances, defining a MWST will start with a standard α=1; however, if the network does not provide the degree of connections necessary, the alpha may need to be loosened (decreased) until it achieves the desired node connectivity. Selecting (e.g., manually or automatically) appropriate or optimal alpha can be performed using known techniques.

### Application of Bayesian Networks to Survey Response Data

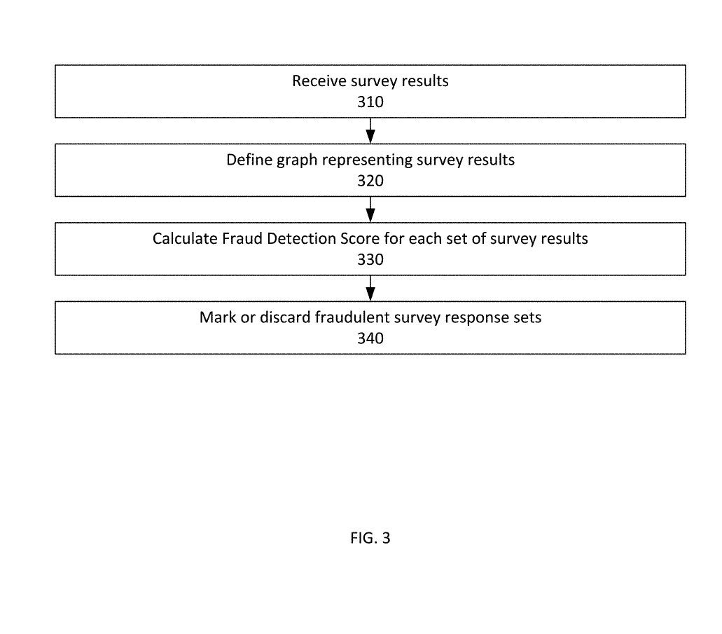

FIG. 3 is a flow chart of a method of applying machine-learned graph to survey results to detect fraudulent responses, according to an embodiment. At 310, survey results can be received. Similarly stated, multiple sets of survey responses can be received and/or ingested. Each set of survey responses can be associated with a different survey taker and can include a response value for each of several questions included within the survey. In some instances, the survey questions themselves are not received, processed, or otherwise used to define a graph and/or analyze survey results for indications of fraud. In addition or alternatively, in some instances the method can further include generating the survey, however, a graph representing the survey responses can be defined only after the survey responses are received and the graph may not be based on the questions themselves.

In some instances, survey results are processed. For example, responses to open questions from a survey (e.g., questions prompting the survey taker to provide a free-form text answer) can be removed and continuous data from the survey results (e.g., answers to questions related to the survey taker's age, income, weight, etc.) can be discretized. A graph (e.g., a Bayesian Network, a MWST, and/or a DAG) representation of that survey and/or the survey results can be defined at 320. Similarly stated, the existence of survey questions (if not the content of survey questions) can be inferred from the presence of answers contained within the survey results. Nodes of the graph can represent survey questions. Each node can be connected to at least one other node by an edge that represents mutual information or other measure of influence a response to one question has on a response to another question. The edges can be directional, such that each edge represents “causal” or other one-way measure of what a response to one question reveals about a response to another question. Typically, edges will have a weight that represent a measure of mutual information, but it is understood that mutual information has a strong relationship to conditional and joint entropy and Kullback-Leibler divergence. Therefore it should be understood that weights of edges could also represent conditional and joint entropy and/or Kullback-Leibler divergence.

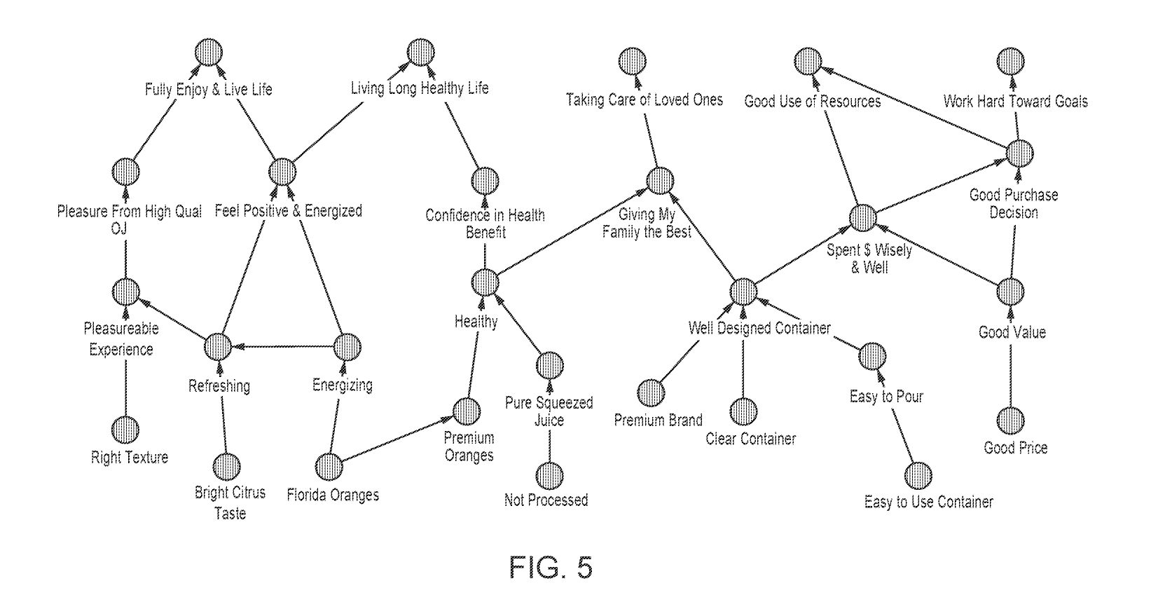

In some instances, the graph, when machine learned, will capture much, most, or all the sufficiency substantive mutual information relationships in the survey response data. FIG. 5 is an example Bayesian network representing a survey about preferences in fresh-squeezed orange juice brand decisions that included questions related to what features were important when choosing an orange juice brand. In some instances, there may be more survey questions than nodes, for example, when responses to one or more survey questions is not found to reveal any information about a response to any other question, a node associated with that question may not be defined or included within the graph.

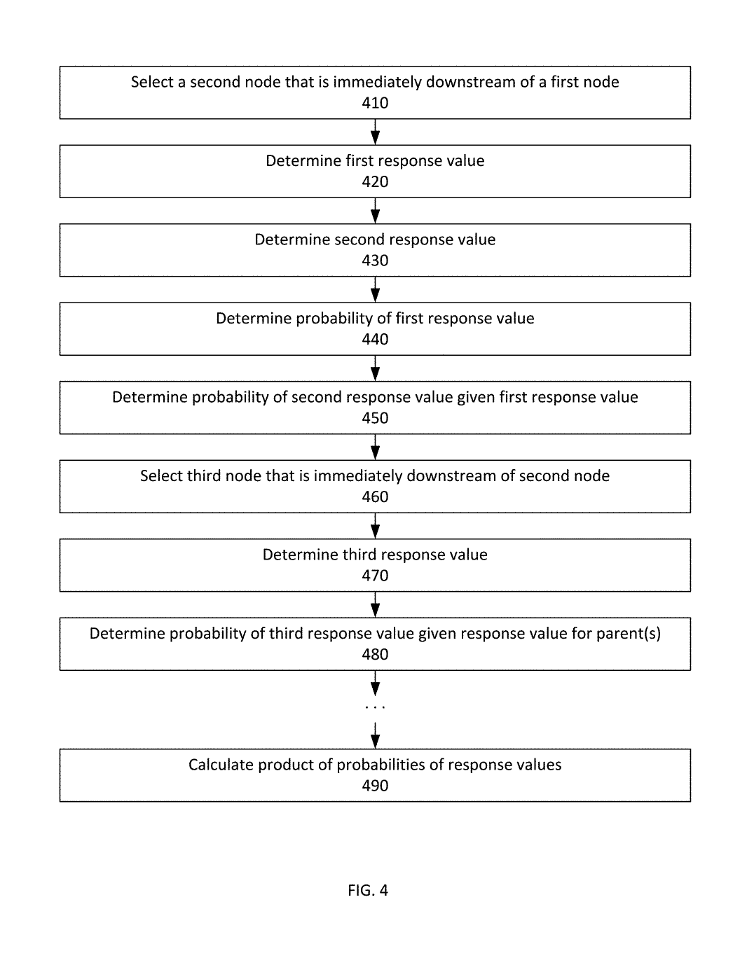

The graph can then be used to compute the probability of each survey response set, at 330. FIG. 4 is an expanded flow chart of a method of computing a probability of a survey response set, according to an embodiment. In some instances, equation 2 discussed above can be used to determine the probability of a survey response set, but in many instances it may be preferable to scale the probability of a survey response set assuming question independence so that a survey taker is not punished for just having less common answers to some questions, even though the less common answers link well enough to their related other questions as predicted by the graph. Equation 4, therefore is a suitable formula for calculating a Fraud Detection Score (FDS) of a survey response set X of length n.

$$FDS ( X ) = \frac{{\prod }_{i = 1}^{n} P ( {X}_{i} \vert parents ( {X}_{i} ) )}{{\prod }_{i = 1}^{n} P ( {X}_{i} )} \qquad ( 4 )$$

Thus, when calculating a fraud detection score, a set of two nodes connected by a directional edge are selected, i.e., a second node that is immediately downstream of a first node connected by that directional edge, at 410. Typically the calculation will be initialized by selecting a “first node” that has no incoming edges. Similarly stated, it may be preferable to initiate the calculation by selecting as a first node a node with no parents/upstream nodes, rather than initializing the calculation of the FDS in the “middle” of a graph.

The response values in a given survey response set for the questions represented by the first node and the second node can be retrieved or determined, at 420 and 430, respectively. A probability of the response value of the first node can be determined, at 440. In an instance in which the first node has no parent, the probability of the response value of the first node is simply a measure of where the response value for the first question in the given survey response set falls on a distribution function of all responses to the first question.

At 450, the probability of the second response value given the first response value can be determined, for example based on an independent measure of the probability of the second response value (e.g., encoded in the second node), a weight of the edge connecting the second node to the first node, and the value of the first response value. This process can be repeated until the probability of each response value in the given survey response set and/or the probability value for each node is determined. For example, a third node that is immediately downstream of the second node can be selected at 460, a response value for a question represented by the third node can be determined, at 470, and a probability of the third response value given the probability of the second response value (and, optionally, given the first response value) can be determined at 480. Once the probability of each response value for the given survey response set is determined, a product of those probabilities can be calculated, at 490, which can produce an FDS and/or based on which an FDS can be calculated. (E.g., equation 2 can be calculated.) In some instances, the product of probabilities can be divided by a product of the probability each response assuming question independence, which can produce an FDS and/or based on which an FDS can be calculated. (E.g., equation 4 can be calculated.)

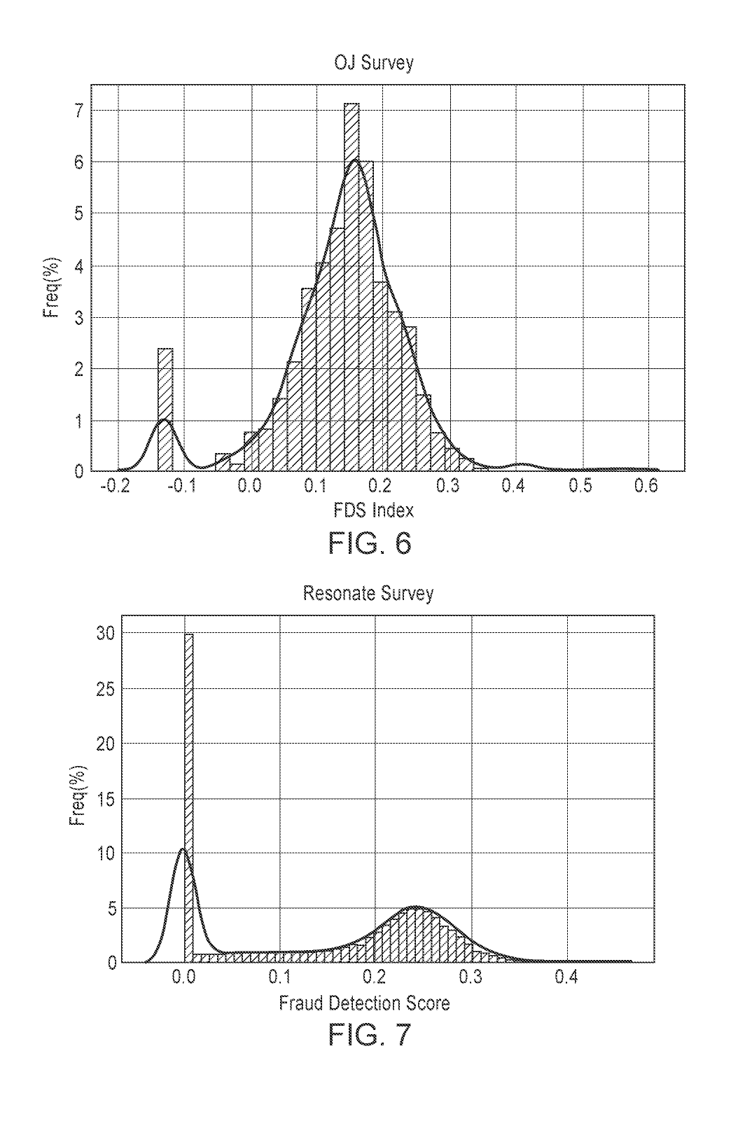

Fraud detection scores can be calculated in this way for each survey response set. The fraud detection scores for each survey response set can define a distribution function. FIGS. 6 and 7 are example distributions of FDSs for survey responses. As shown in FIG. 6, only 2.5% of survey response sets contain fraudulent or bad data. This low level of fraud is likely the result of the survey being a small volunteer survey. This small percentage of fraudulent survey responses, however, is clearly visible as a spike at a FDS index of approximately −0.1. FIG. 7 is more typical for commissioned surveys and shows that 30% of survey response sets include fraudulent data represented by the spike occurring at a FDS of approximately 0.0. Given the asymmetry of the distribution and the fat tail on the left side of the bell curve (e.g., response sets having FDS values between 0.03 and 1.5), there is likely another 10% of survey response sets that include at least partially bad data as well.

Returning to FIG. 3, at 340, fraudulent survey response sets can be discarded, scored, or otherwise marked such that summary metrics describing the survey results collectively can omit or correct for the presence of fraudulent or questionable data. Similarly stated, a revised set of survey response data can be defined that does not contain fraudulent survey response sets and/or that assigns a lower weight to fraudulent survey response sets. In some embodiments, survey response sets having a FDS of 0.15 or less can be discarded as fraudulent. Any other measure can be used to determine that a survey response set is fraudulent, such as a determination that a survey response set is a statistical outlier, that a survey response set is more than two standard deviations below a median FDS, based on a survey response set being associated with a lower mode of the distribution of FDSs, based on a skewness or other asymmetry in distribution of FDSs, etc.

Thus, the initial set of survey results, received at 310, which was contaminated with an unknown level of fraudulent response data, can be sanitized, transformed, reduced in quantity, have an increased signal, and/or otherwise filtered to produce a revised data set that is more suitable for analysis.

### Applications

One or more of the embodiments described herein allows for or enables a number of survey-based applications, methods, procedures and/or computer-implemented systems including, for example, the following:
1. Multimillion or even multibillion dollar business decisions are regularly made on the results of survey-based market research. Fraudulent data infuses these datasets with near random or skewed entries that impact market pricing, product introductions, segment definitions, etc. Legitimate opportunities are passed over and poor opportunities are invested in because of the inability to clean, or even detect, fraudulent responses in the research data sets. The fraud detection scores produced by methods described herein can be used on such datasets to remove some or all of the fraudulent data, thereby allowing businesses (and their related personal and/or computer systems) to make decisions to proceed with business opportunities that might otherwise be passed over and/or make decisions not proceed with poor business opportunities that might otherwise be pursued.
2. Survey panel companies are typically willing to refund the sample costs associated with respondents that provide bad data. Current technologies tend to identify less than 5% of data as being fraudulent, when the actual occurrence of fraud is closer to 20-30%. The current inability to identify the bad data leads to billions of dollars lost to research clients each year. The fraud detection scores produced by methods described herein can be used on such datasets to identify such bad data and allow a business to obtain a refund from a survey panel company(ies) that otherwise the business might be not be obtain.
3. Some survey takers make a living off providing quick and thoughtless responses to as many surveys as they can complete. In addition, recent years have seen the advent of malicious bots that act like humans in accepting survey requests, and then randomly fill in responses, garnering significant ill-gotten gain for the sponsoring organizations. Fraud detections scores provide an easy and automatable way to detect and shut down both fraudulent human behavior and malicious bots on a network that includes computers as survey takers. In other words, the fraud detection scores produced by methods described herein can be used to detect (or identify) such fraudulent humans and/or malicious bots (or automated computer-based systems/applications) and block such fraudulent humans (e.g., through an identification of their computer characteristics such IP address) and/or malicious bots from future participation in surveys. For example, in some instances, IP addresses, user names, or other suitable identifiers can be blacklisted or otherwise prevented from participating in future surveys based on submitting surveys with low fraud detection scores.

While various embodiments have been described above, it should be understood that they have been presented by way of example only, and not limitation. Furthermore, although various embodiments have been described as having particular features and/or combinations of components, other embodiments are possible having a combination of any features and/or components from any of embodiments where appropriate as well as additional features and/or components. For example, some embodiments described herein relate to either a calculation of a model-based joint probability, or standardizing that calculation by looking at the ratio of the model-based joint probability to the joint probability generated by a Bayesian network with fully disconnected Bayesian network (i.e., the product of the unconditional probabilities associated with each node). Modeling approaches described herein are for example only and it should be understood that other model approaches could be taken, including correlational or covariance approaches, structural equation model (SEM) structure searches, or other machine learning techniques to discover the same or similar relationships between nodes—a relationship that is characterized by a lack of independence. Additionally, when described above, edges are frequently discussed as representing mutual information of nodes. It should be understood, however, that while it is possible to have positive mutual information without correlation, it is impossible to have significant correlation without having positive mutual information, so the above descriptions cover any correlational approach to the same end.

Although not always explicitly stated above, it should be understood that the above-described calculations and modeling can be performed, for example, by a computer that receives the survey data, performs the above-described calculations and modeling using the survey data, and then provides an output to indicate the results of the calculations/modeling. This computer can include a processor coupled to a memory, which stores processor-readable instructions to be executed by the processor and based on the method, calculations, and models described above.

Similarly, the survey data can be collected by multiple computers each accessed by a given survey taker and each including a processor coupled to a memory, which stores processor-readable instructions to be executed by that processor. The survey data can be generate, for example, via a browser that accesses a website that directs the taking of the survey data. The survey data from various survey takers can be, for example, sent over a network to a repository to aggregate the survey data and provide the aggregation to the computer to perform the calculations/modeling, etc. Such a repository can be, for example, a centralized database stored on a server and accessible by the computer that performs the above-described calculations and modeling using the survey data. The network can be, for example, the Internet, a private network, a wired network and/or a wireless network.

In some embodiments, the systems (or any of its components) described herein can include a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules, Read-Only Memory (ROM), Random-Access Memory (RAM) and/or the like. Examples of hardware devices configured to store and execute program code include: general purpose processors, Field Programmable Gate Arrays (FPGAs), Application Specific Integrated Circuits (ASICs), Digital Signal Processor (DSPs), Programmable Logic Devices (PLDs), and the like. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Where methods described above indicate certain events occurring in certain order, the ordering of certain events may be modified. Additionally, certain of the events may be performed concurrently in a parallel process when possible, as well as performed sequentially as described above. Although various embodiments have been described as having particular features and/or combinations of components, other embodiments are possible having a combination of any features and/or components from any of the embodiments where appropriate.

What is claimed is:

1. A non-transitory processor-readable medium storing code representing instructions to be executed by a processor, the code comprising code to cause the processor to:
receive a plurality of survey response sets, each survey response set from the plurality of survey response sets including a discrete response value for at least one field from a plurality of fields;
define a directed acyclical graph having a plurality of nodes and a plurality of edges, each node from the plurality of nodes representing a field from the plurality of fields, each edge from the plurality of edges directionally connecting one node from the plurality of nodes to another node from the plurality of nodes, each edge from the plurality of edges including a weight representing a probabilistic measure that a response value for a field represented by a downstream node will influence a response value for a field represented by an upstream node;
calculate a fraud detection score for a survey response set from the plurality of survey response sets by:
selecting a second node, the second node immediately downstream a first node;
determining a first response value in the survey response set for a first field represented by the first node;
determining a second response value in the survey response set for a second field represented by the second node;
determining a probability of the second response value given the first response value based on a weight of an edge connecting the first node and the second node;
determining a third response value in the survey response set for a third field represented by a third node, the third node immediately downstream of the second node;
determining a probability of the third response value given the second response value based on a weight of an edge connecting the second node and the third node; and
calculating a product of the probability of the second response value given the first response value and the probability of the third response value given the second response value, the fraud detection score based on the product of the probability of the second response value given the first response value and the probability of the third response value given the second response value; and
defining a revised plurality of survey response sets, the revised plurality of survey response sets excluding the survey response set based on the fraud detection score being below a threshold value.

2. The non-transitory processor-readable medium of claim 1, the code further comprising code to cause the processor to:
generate a survey, each survey response set from the plurality of survey response sets including responses to responses to at least one question from the survey;
the directed acyclical graph defined after the survey is generated and after the plurality of survey response sets are received.

3. The non-transitory processor-readable medium of claim 1, wherein the probability of the third response value given the second response value is also the probability of the third response value given the second response value and the first response value, and is determined based on the weight of the edge connecting the third node to the second node and the weight of the edge connecting the second node to the first node.

4. The non-transitory processor readable medium of claim 1, wherein the threshold value is no greater than 0.15.

5. The non-transitory processor readable medium of claim 1, wherein calculating the fraud detection score further includes dividing the product of the probability of the second response value given the first response value and the probability of the third response value given the second response value by a product of a probability of the second response value and a probability of the third response value.

6. A non-transitory processor-readable medium storing code representing instructions to be executed by a processor, the code comprising code to cause the processor to:
receive a plurality of survey response sets, each survey result from the plurality of survey including a response value for at least one question from a plurality of questions;
define a maximum weight spanning tree representing at least a portion of the plurality of questions, the maximum weight spanning tree having a plurality of nodes, each node from the plurality of nodes representing a question from the plurality of questions, and a plurality of edges, each edge from the plurality of edges directionally connecting one node from the plurality of nodes to another node from the plurality of nodes;
define a weight for each edge from the plurality of edges, the weight for each edge representing mutual information of two nodes connected by that edge;
for each survey result from the plurality of survey response sets, assign a fraud detection score using the maximum weight spanning tree, the fraud detection score for that survey result based on a conformance of response values for that survey result to the mutual information represented by the plurality of edges of the maximum weight spanning tree;
determining a distribution of the fraud detection scores; and
classify a subset of the plurality of survey response sets as fraudulent based on the fraud detection scores associated with the subset of the plurality of survey response sets being statistical outliers in the distribution of the fraud detection scores.

7. The non-transitory processor readable medium of claim 6, wherein the fraud detection scores for the subset of the plurality of survey response sets are at least two standard deviations below a median fraud detection score of the plurality of survey response sets.

8. The non-transitory processor readable medium of claim 6, wherein:
the distribution of the fraud detection scores is multimodal; and
the fraud detection scores for the subset of the plurality of survey response sets are associated with a lowermost mode of the distribution.

9. The non-transitory processor readable medium of claim 6, wherein, for each survey result from the plurality of survey response sets, the fraud detection score is assigned according to the following formula:
$$FDS ( X ) = \frac{{\prod }_{i = 1}^{n} P ( {X}_{i} \vert parents ( {X}_{i} ) )}{{\prod }_{i = 1}^{n} P ( {X}_{i} )}$$
where FDS is the fraud detection score,
X is the value of a response value from the plurality of response values for that survey result, and
n is the number of nodes in the plurality of nodes.

10. The non-transitory processor-readable medium of claim 6, wherein receiving the plurality of survey response sets does not include receiving survey questions such that the maximum weight spanning tree is defined based on survey response values and not the plurality of questions.

11. The non-transitory processor-readable medium of claim 6, wherein the maximum weight spanning tree is a directed acyclic graph.

12. The non-transitory processor-readable medium of claim 6, wherein a number of questions in the plurality of questions is greater than a number of node in the plurality of nodes such that some questions from the plurality of questions are not represented by nodes.

13. The non-transitory processor-readable medium of claim 6, wherein the subset of the plurality of survey response sets are classified as fraudulent based on the fraud detection scores for the subset of the plurality of survey response sets being in an asymmetry tail of the distribution.

14. A non-transitory processor-readable medium storing code representing instructions to be executed by a processor, the code comprising code to cause the processor to:
receive a plurality of survey response sets, each survey result from the plurality of survey response sets including a response value for at least some of a plurality of questions;
define a Bayesian network representing the plurality of survey response sets, the Bayesian network having a plurality of nodes and a plurality of edges, each node from the plurality of nodes representing a question from the plurality of questions, each edge from the plurality of edges being directional and connecting two nodes, each edge from the plurality of edges repenting an amount of information a response value for a question represented by an upstream node reveals about a value of a response value for a question represented by a downstream node;
select, from a survey result from the plurality of survey response sets, a first response value for a first question and a second response value for a second question, the first question represented by a first node from the plurality of nodes and the second question represented by a second node from the plurality of nodes, the second node being downstream of the first node;
calculate a fraud detection score for the survey result based on the first response value, the second response value, and a weight of an edge from the plurality of edges that is between the first node and the second node; and
mark the survey result as fraudulent based on the fraud detection score being below a threshold value.

15. The non-transitory processor-readable medium of claim 14, wherein a third node from the plurality of nodes is downstream of the second node, the fraud detection score for the survey result based on the first response value, the second response value, and a third response value for a third question represented by the third node.

16. The non-transitory processor-readable medium of claim 14, the code further comprising code to cause the processor to define the weight for each edge from the plurality of edges based on a simultaneity metric for the two nodes connected by that edge.

17. The non-transitory processor-readable medium of claim 14, the code further comprising code to cause the processor to define the weight for each edge from the plurality of edges based on conditional and joint entropy for the two nodes connected by that edge.

18. The non-transitory processor-readable medium of claim 14, wherein defining the Bayesian network includes:
defining maximum weight spanning tree; and
after the maximum weight spanning tree is defined, optimizing the Bayesian network using a Tabu algorithm.

19. The non-transitory processor-readable medium of claim 14, the code further comprising code to cause the processor to:
define a preliminary Baysian network using a preliminary structural coefficient of 1;
determine that a measure of connectivity of the preliminary Baysian network is below a threshold value;
select a structural coefficient that is less than the preliminary structural coefficient based on the measure of connectivity of the preliminary Bayesian network, the Baysian network defined using the structural coefficient.

20. The non-transitory processor-readable medium of claim 14, the code further comprising code to cause the processor to identify a respondent associated with the survey result as a fraudster such that future survey responses from the fraudster are discarded.

21. The non-transitory processor-readable medium of claim 14, the code further comprising code to cause the processor to:
identify an IP address associated with the survey result; and
add the IP address to a blacklist of IP addresses which are blocked from submitting survey response sets.
